(19) United States
(12) Patent Application Publication
(10) Pub. No.: US 2022/0238066 A1
(43) Pub. Date: Jul. 28, 2022

(54) DRIVING CIRCUIT, DRIVING CONTROL METHOD AND DISPLAY PANEL

(71) Applicant: BOE Technology Group Co., Ltd., Beijing (CN)

(72) Inventors: Liang CHEN, Beijing (CN); Dongni LIU, Beijing (CN); Haoliang ZHENG, Beijing (CN); Li XIAO, Beijing (CN); Seungwoo HAN, Beijing (CN); Jiao ZHAO, Beijing (CN); Hao CHEN, Beijing (CN); Minghua XUAN, Beijing (CN); Qi QI, Beijing (CN)

(21) Appl. No.: 17/491,055

(22) Filed: Sep. 30, 2021

(30) Foreign Application Priority Data
Jan. 26, 2021 (CN) 202110101627.6

(51) Int. Cl. G09G 3/32

(52) U.S. Cl. CPC G09G 3/32; G09G 2310/08; G09G 2300/0842; G09G 2300/0426; G09G 2310/0243

(57) ABSTRACT

The present application discloses a driving circuit and a display panel. The driving circuit includes a driving current generation circuit and a light emitting time control circuit. The driving current generation circuit is connected to a first reference voltage terminal, a data voltage terminal and the light emitting time control circuit, and is configured to generate a driving current under the control of the first reference voltage terminal and the data voltage terminal, and transmit the driving current to the light emitting time control circuit. The light emitting time control circuit is connected to the driving current generation circuit, a time control signal terminal, a reference signal terminal and a light emitting element, and is configured to control a duration of transmitting the driving current to the light emitting element under the control of the time control signal terminal and the reference signal terminal.

### CROSS-REFERENCE TO RELATED APPLICATION

The present application claims the priority of Chinese Patent Application No. 202110101627.6 filed on Jan. 26, 2021, the contents of which are incorporated herein in their entirety by reference.

### TECHNICAL FIELD

The present disclosure relates to the field of display technology, and in particular to a driving circuit, a driving control method, and a display panel.

### BACKGROUND

Micro LED display technology has the advantages of low power consumption, high brightness, ultra-high resolution and color saturation, fast response speed, power saving, long life, high efficiency, etc., and is considered to be the most competitive next-generation display technology. Generally, the light emitting efficiency of the micro LEDs at a low current density will decrease with the decrease of the current density, resulting in changes in the chromaticity coordinates of the micro LEDs.

### SUMMARY

A driving circuit according to an embodiment of the present application is used to drive a light emitting element, the driving circuit includes a driving current generation circuit and a light emitting time control circuit,

the driving current generation circuit is connected to a first reference voltage terminal, a data voltage terminal and the light emitting time control circuit, and is configured to generate a driving current under the control of the first reference voltage terminal and the data voltage terminal, and transmit the driving current to the light emitting time control circuit;

the light emitting time control circuit is connected to the driving current generation circuit, a time control signal terminal, a reference signal terminal and a light emitting element, and is configured to control a duration of transmitting the driving current to the light emitting element under the control of the time control signal terminal and the reference signal terminal.

In some embodiments, the light emitting time control circuit includes a first transistor and a second transistor,

a first electrode of the first transistor is connected to the driving current generation circuit, a second electrode of the first transistor is connected to the light emitting element;

a gate of the second transistor is connected to the reference signal terminal, a first electrode of the second transistor is connected to the time control signal terminal, a second electrode of the second transistor is connected to a gate of the first transistor.

In some embodiments, the driving current generation circuit includes a drive transistor, the first electrode of the first transistor is connected to a second electrode of the drive transistor, a gate of the drive transistor is connected to the data voltage terminal, a first electrode of the drive transistor is connected to the first reference voltage terminal.

In some embodiments, the driving circuit includes a threshold compensation circuit, the threshold compensation circuit is connected to the gate of the drive transistor, the second electrode of the drive transistor, and a gate control terminal, and is configured to compensate a threshold voltage of the drive transistor under the control of the gate control terminal.

In some embodiments, the threshold compensation circuit includes a threshold compensation transistor, a gate of the threshold compensation transistor is connected to the gate control terminal, a first electrode of the threshold compensation transistor is connected to the gate of the drive transistor, a second electrode of the threshold compensation transistor is connected to the second electrode of the drive transistor.

In some embodiments, the driving circuit includes a data write circuit, the data write circuit is connected to the driving current generation circuit, the gate control terminal and a data write terminal, and is configured to write to the data voltage terminal a data voltage provided by the data write terminal under the control of the gate control terminal.

In some embodiments, the data write circuit includes a data write transistor, a gate of the date write transistor is connected to the gate control terminal, a first electrode of the data write transistor is connected to the first electrode of the drive transistor, a second electrode of the data write transistor is connected to the data write terminal.

In some embodiments, the driving circuit includes a light emitting control circuit, the light emitting control circuit is connected to the first reference voltage terminal, the light emitting control terminal and the driving current generation circuit, and is configured to cause the driving current generation circuit to be connected to the first reference voltage terminal under the control of the light emitting control terminal.

In some embodiments, the light emitting control circuit includes a light emitting control transistor, a gate of the light emitting control transistor is connected to the light emitting control terminal, a first electrode of the light emitting control transistor is connected to the first reference voltage terminal, a second electrode of the light emitting control transistor is connected to the first electrode of the drive transistor.

In some embodiments, the driving circuit includes a reset circuit, the reset circuit is connected to a reset control terminal, a reset voltage terminal, the driving current generation circuit and the light emitting time control circuit, and is configured to reset the driving current generation circuit and/or the light emitting time control circuit under the control of the reset control terminal.

In some embodiments, the reset circuit includes a first reset sub-circuit and a second reset sub-circuit;

the first reset sub-circuit is connected to the reset control terminal, the reset voltage terminal and the driving current generation circuit, and is configured to reset the driving current generation circuit under the control of the reset control terminal;

the second reset sub-circuit is connected to the reset control terminal, the reset voltage terminal and the light emitting time control circuit, and is configured to reset the light emitting time control circuit under the control of the reset control terminal.

In some embodiments, the first reset sub-circuit includes a first reset transistor, a gate of the first reset transistor is connected to the reset control terminal, a first electrode of the first reset transistor is connected to the data voltage terminal, a second electrode of the first reset transistor is connected to the reset voltage terminal;

the second reset sub-circuit includes a second reset transistor, a gate of the second reset transistor is connected to the reset control terminal, a first electrode of the second reset transistor is connected to the gate of the first transistor, a second electrode of the second reset transistor is connected to the reset voltage terminal.

In some embodiments, the driving circuit includes a voltage regulator circuit, the voltage regulator circuit is connected to a common voltage terminal, the first reference voltage terminal, the driving current generation circuit and the light emitting time control circuit, and is configured to keep control voltages corresponding to the driving current generation circuit and the light emitting time control circuit stable.

In some embodiments, the voltage regulator circuit include a first voltage regulator sub-circuit, a second voltage regulator sub-circuit and a third voltage regulator sub-circuit;

the first voltage regulator sub-circuit is connected to the first reference voltage terminal and the data voltage terminal;

the second voltage regulator sub-circuit is connected to the common voltage terminal and the gate of the second transistor;

the third voltage regulator sub-circuit is connected to the common voltage terminal and the gate of the first transistor.

In some embodiments, the first voltage regulator sub-circuit includes a first storage capacitor, a first electrode of the first storage capacitor is connected to the first reference voltage terminal, a second electrode of the first storage capacitor is connected to the data voltage terminal;

the second voltage regulator sub-circuit includes a second storage capacitor, a first electrode of the second storage capacitor is connected to the gate of the second transistor, a second electrode of the second storage capacitor is connected to the common voltage terminal;

the third voltage regulator sub-circuit includes a third storage capacitor, a first electrode of the third storage capacitor is connected to the gate of the first transistor, a second electrode of the third storage capacitor is connected to the common voltage terminal.

In some embodiments, the driving circuit includes a reference signal write circuit, the reference signal write circuit is connected to the reference signal terminal, a gate control terminal and the light emitting time control circuit, and is configured to cause the light emitting time control circuit to be connected to the reference signal terminal under the control of the gate control terminal.

In some embodiments, the reference signal write circuit includes a third transistor, a gate of the third transistor is connected to the gate control terminal, a first electrode of the third transistor is connected to the reference signal terminal, a second electrode of the third transistor is connected to the gate of the second transistor.

A driving control method according to an embodiment of the present application is used in any of the above driving circuits, wherein a display period includes a compensation stage and a light emitting stage, and the driving control method includes:

in the compensation stage, the data voltage terminal providing and storing a data voltage signal, and the reference signal terminal providing and storing a reference signal;

in the light emitting stage, the time control signal terminal providing multiple segments of time control signals with different magnitudes, the driving current generation circuit generating a driving current under the control of a first reference signal provided by the first reference voltage terminal and the data voltage signal stored by the data voltage terminal, and transmitting the driving current to the light emitting time control circuit, the light emitting time control circuit controlling a duration of transmitting the driving current to the light emitting element according to magnitudes of the multiple segments with time control signals and the reference voltage signal and a duration of each segment of time control signal.

In some embodiments, the durations of the multiple segments of time control signals of different magnitudes are different from each other.

In some embodiments, a light emitting duration of the light emitting element is a sum of the durations of the segments of time control signals which a difference between a signal value and the reference signal is greater than a preset value.

A display panel according to an embodiment of the present application includes a light emitting element and any of the above driving circuits, the driving circuit is used for driving the light emitting element to emit light.

A display panel according to an embodiment of the present application includes a light emitting element and the driving circuit in any of the above embodiments, the driving circuit is used for driving the light emitting element to emit light.

The additional aspects and advantages of the driving current generation circuit of the present application will be partly given in the following description, and partly become obvious from the following description, or be understood through the practice of the present application.

### BRIEF DESCRIPTION OF THE DRAWINGS

The above and/or additional aspects and advantages of the present application will become apparent and easy to understand from the description of the embodiments in conjunction with the following drawings, in which:

FIG. 1 is a schematic circuit diagram of a driving circuit according to an embodiment of the present application.

FIG. 2 is a schematic diagram of a driving circuit according to an embodiment of the present application.

FIG. 3 is a schematic driving timing diagram of a driving circuit according to an embodiment of the present application.

FIG. 4 is a schematic circuit diagram of a display panel according to an embodiment of the present application.

### REFERENCE NUMERALS

driving circuit 10, driving current generation circuit 11, drive transistor T3;

light emitting time control circuit 12, first transistor T7, second transistor T9;

threshold compensation circuit 13, threshold compensation transistor T4;

data write circuit 14, data write transistor T2;

light emitting control circuit 15, light emitting control transistor T5;

reset circuit 16, first reset sub-circuit 162, first reset transistor T1, second reset sub-circuit 164, second reset transistor T6;

voltage regulator circuit 17, first voltage regulator sub-circuit 172, first storage capacitor C1, second voltage regulator sub-circuit 174, second storage capacitor C2, third voltage regulator sub-circuit 176, third storage capacitor C3;

reference signal write circuit 18, third transistor T8;

first reference voltage terminal VDD, first reference voltage Vdd, data voltage terminal Vg, time control signal terminal EM1(N), time control signal em1(n), reference signal terminal DATA T, reference signal data t(n), gate control terminal GATE(N), gate control signal gate(n), data write terminal DATA I, data voltage data I(n), light emitting control terminal EMC, light emitting control signal emc(n), reset control terminal GATE(N−1), reset control signal gate(n−1), reset voltage terminal VIN, reset voltage Vinit, second reference voltage terminal VSS, second reference voltage Vss, common voltage terminal VC, common voltage Vcom; display panel 100.

### DETAILED DESCRIPTION

The embodiments of the present application are described in detail below. Examples of the embodiments are shown in the accompanying drawings, in which the same or similar reference numerals indicate the same or similar elements or elements with the same or similar functions. The following embodiments described with reference to the drawings are exemplary, and are merely explanation of the present application instead of a limitation to the present application.

In the description of this application, it should be understood that the orientation or positional relationship indicated by the terms “center”, “longitudinal”, “lateral”, “length”, “width”, “thickness”, “upper”, “lower”, “front”, “back”, “left”, “right”, “vertical”, “horizontal”, “top”, “bottom”, “inside”, “outside”, “clockwise”, “counterclockwise”, etc. are based on the orientation or positional relationship shown in the drawings, and is only for the convenience of describing the application and simplifying the description, rather than indicating or implying that the device or element referred to must have a specific orientation, be constructed and operated in a specific orientation, and therefore cannot be understood as a limitation of the present application. In addition, the terms “first”, “second”, etc. are only used for descriptive purposes, and cannot be understood as indicating or implying relative importance or implicitly indicating the number of indicated technical features. Therefore, the features defined with “first”, “second”, etc. may explicitly or implicitly include one or more of the features. In the description of the present application, “multiple” means two or more than two, unless otherwise specifically defined.

In the description of this application, it should be noted that, unless otherwise clearly specified and limited, the terms “mounted”, “connected” and “coupled” should be interpreted broadly; for example, it may refer to a fixed connection or a detachable connection, or an integral connection; it may refer to a mechanical connection, or an electrical connection or a communication with each other; it may refer to a direct connection, or an indirect connection through an intermediate medium; it may refer to an internal communication of two elements or an interaction of two elements. For those of ordinary skill in the art, the specific meanings of the above terms in this application can be understood according to specific circumstances.

In this application, unless otherwise expressly prescribed and defined, a first feature being “above” or “below” a second feature may include that the first feature being in direct contact with the second feature, or may include the first and second features not being in direct contact but contact with each other through other features between them. Moreover, a first feature being “above”, “on”, “over” a second feature may include the first feature being directly above and obliquely above the second feature, or it simply means that the level of the first feature is higher than that of the second feature. A first feature being “below”, “under”, “beneath” a second feature may include the first feature directly below and obliquely below the second feature, or it simply means that the level of the first feature is lower than the second feature.

The following provides many different embodiments or examples for implementing different structures of the present application. In order to simplify the disclosure of the present application, the components and settings of specific examples are described below. Obviously, they are only examples, and are not intended to limit the application. In addition, the present application may repeat reference numerals and/or reference letters in different examples. Such repetition is for the purpose of simplification and clarity, and does not indicate the relationship between the various embodiments and/or settings discussed. In addition, this application provides examples of various specific processes and materials, but those of ordinary skill in the art may conceive the application of other processes and/or the use of other materials.

The micro LED display technology is to realize the thin-film, miniaturization and matrixization of LEDs by integrating micro-dimension LED arrays on a chip at a high density. The distance between the pixels can reach the micron level, and each pixel can be addressed and emit light individually. The micro LED display panel has the advantages of low power consumption, high brightness, ultra-high resolution and color saturation, fast response speed, power saving, long life, high efficiency, etc., and is considered to be the most competitive next-generation display technology.

Generally, the efficiency of micro LEDs at low current densities will decrease as the current density decreases, resulting in changes in the chromaticity coordinates of the micro LEDs. The inventor found that, if different gray levels in a frame of image is achieved by superimposing n images of different light emitting durations, this requires that a row of pixels should be scanned n times in the full screen within a frame time, and n data signals are input. For large-size products or high-resolution products, multiple scans within one frame time will result in insufficient charging rate and abnormal display.

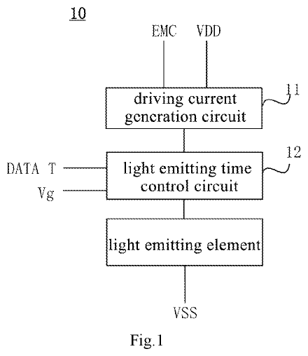

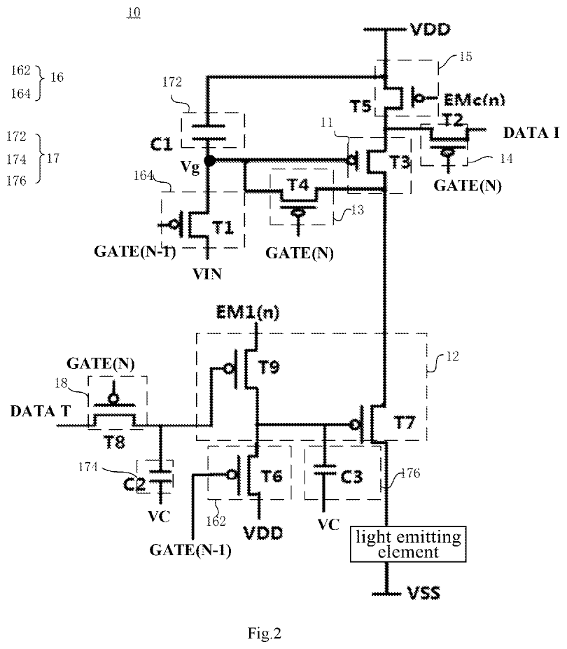

In view of this, now referring to FIGS. 1 and 2, an embodiment of the present application provides a driving circuit 10 for driving a light emitting element. The driving circuit 10 includes a driving current generation circuit 11 and a light emitting time control circuit 12.

The driving current generation circuit 11 is connected to a first reference voltage terminal VDD, a data voltage terminal Vg and the light emitting time control circuit 12, and is configured to generate a driving current under the control of the first reference voltage terminal VDD and the data voltage terminal Vg, and transmit the driving current to the light emitting time control circuit 12. The light emitting time control circuit 12 is connected to the driving current generation circuit 11, a time control signal terminal EM1(N), a reference signal terminal DATA T, and a light emitting element, and is configured to control a duration of transmitting the driving current to the light emitting element under the control of the time control signal terminal EM1(N) and the reference signal terminal DATA T.

In the driving circuit 10 of the embodiment of the present application, by setting the driving current generation circuit 11 and the light emitting time control circuit 12, the light emitting time control circuit 12 controls the duration of transmitting the driving current to the light emitting element under the control of the time control signal and the reference signal terminal DATA T. In this way, the gray level can be modulated by both the driving current and the light emitting time, which avoids the display color cast of the light emitting element, and improves the display quality.

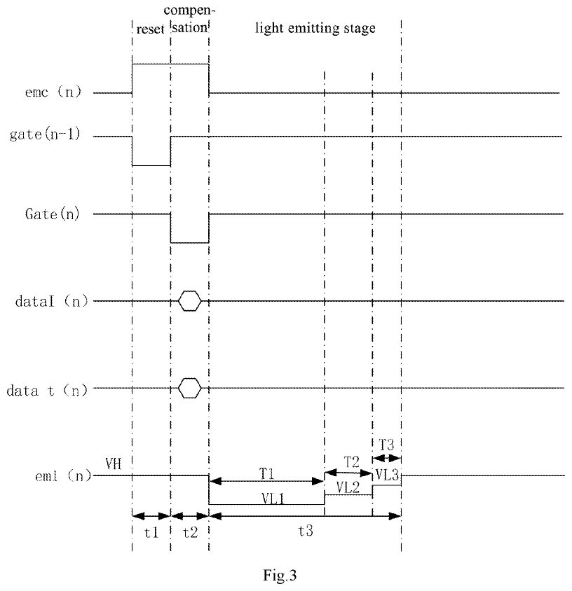

Referring to FIG. 3 as well, it should be noted that, the first reference voltage terminal VDD is used to transmit the first reference voltage Vdd to the driving current generation circuit 11, and the data voltage terminal Vg is used to transmit the data voltage data I(n) to the driving current generation circuit 11. The time control signal terminal EM1(N) is used to transmit the time control signal em1(n) to the light emitting time control circuit 12, and the reference signal terminal DATA T is used to transmit the reference signal data t(n) to the light emitting time control circuit 12. The light emitting time control circuit 12 is used to control the transmission of the driving current to the light emitting element according to the reference signal data t(n) of the reference signal terminal DATA T and the time control signal em1(n).

It will be appreciated that the gray level of the light emitting element in each frame of image is not the same. The embodiment of the present application can make the driving current be at a level that can ensure the micro LED operates in a working state of stable luminance efficiency and stable chromaticity coordinates by controlling the magnitude of the data voltage data I(n), and achieve different brightnesses of the light emitting element by controlling the duration at the same time. Specifically, the light emitting element may be a micro LED, and each light emitting element characterizes a pixel for displaying an image. An anode of the light emitting element is connected to the driving current generation circuit 11, and a cathode of the light emitting element is connected to the second reference voltage terminal VSS. The driving current generation circuit 11 includes a drive transistor T3, a gate of the drive transistor T3 is connected to the data voltage terminal Vg, a first electrode of the drive transistor T3 is connected to the first reference voltage terminal VDD, and a second electrode of the drive transistor T3 is connected to the light emitting time control circuit 12. The drive transistor T3 is used to generate a driving current according to the potential of the data voltage terminal Vg and the first reference voltage Vdd, and transmit the driving current to the light emitting time control circuit 12.

The light emitting time control circuit 12 includes a first transistor T7 and a second transistor T9. A first electrode of the first transistor T7 is connected to the driving current generation circuit 11, a second electrode of the first transistor T7 is connected to the light emitting element. A gate of the second transistor T9 is connected to the reference signal terminal DATA T, a first electrode of the second transistor T9 is connected to the time control signal terminal EM1(N), a second electrode of the second transistor T9 is connected to a gate of the first transistor T7.

It should be noted that, in the embodiments of the present application, the transistor used may be a thin film transistor, a field effect transistor, or any other switching device with the same characteristics. The source and drain of the transistor used here can be symmetrical in structure, so there may be no difference between the structures of the source and the drain. In the embodiments of the present disclosure, in order to distinguish the two electrodes of the transistor except for the gate, one electrode is described as the first electrode and the other electrode is described as the second electrode. Therefore, in the embodiments of the present disclosure, the sources and the drains of all or some of the transistors may be interchangeable as needed.

In addition, the transistors can be classified into N-type and P-type transistors according to their characteristics. In all the embodiments of the present disclosure, descriptions are made by taking the P-type transistors as examples. That is, in the embodiments of the present application, when the gate of a transistor receives a low-level signal, the first electrode and the second electrode of the transistor are turned on. Based on the description and teaching of the implementations using the P-type transistors in the present disclosure, those of ordinary skill in the art can easily conceive the implementations using the N-type transistors of the embodiments of the present disclosure without creative work. Therefore, these implementations are also within the protection scope of the present disclosure.

Further referring to FIG. 3 as well, it should be noted that, the magnitude of the data voltage data I(n) can be adjusted to control the drive transistor T3 to generate a driving current. It will be appreciated that, since the drive transistor T3 is a P-type transistor, the greater the magnitude of the data voltage data I(n), the greater the driving current generated by the drive transistor T3. The time control signal em1(n) and the reference signal data t(n) are both level signals. The time control signal em1(n) includes a high-level signal VH and a low-level signal VL. Among them, the low-level signal consists of multiple segments of control sub-signals of different magnitudes (for example: VL1, VL2, VL3 in FIG. 3), and the durations of the multiple segments of control sub-signals are different from each other. When the gate of the first transistor T7 receives the control sub-signal, it is turned on, and when the gate of the first transistor T7 receives the high-level signal VH, it is turned off. The magnitude of the reference signal data t(n) can be adjusted, and the second transistor T9 is used to control the output of the control sub-signal according to the reference signal data t(n).

Further, the second transistor T9 includes a threshold voltage Vth. After the gate of the second transistor T9 receives the reference signal data t(n), a control sub-signal of the reference signal data t(n) that is greater than a sum of the reference signal data t(n) and the threshold voltage Vth is output to the gate of the first transistor T7 to control the duration of turning on of the first transistor T7. The light emitting duration of the light emitting element is a sum of the durations of the segments of time control signals em1(n) which a difference between the reference signal value and the reference signal data t(n) is greater than a preset value.

It will be appreciated that, since the control sub-signals have different magnitudes and durations, and a corresponding number of multiple segments of control sub-signals that are greater than the sum of the reference signal data t(n) and the threshold voltage Vth are output to the gate of the first transistor T7, controlling the magnitude of reference signal data t(n) can achieve the output of different numbers of control sub-signals to the gate of the first transistor T7, thereby controlling the on-time duration and off-time duration of the first transistor T7, and achieving control of the light emitting time of the light emitting element.

In FIG. 3, the levels of the control sub-signal VL1, the control sub-signal VL2, and the control sub-signal VL3 become larger in turn, and their durations become shorter in turn. In addition, the gray level of the light emitting element may be different in each frame, while the multiple control sub-signals included in the time control signal em1(n) may be exactly the same in each frame. Different light emitting durations is achieved by inputting different reference signal data t(n) in each frame, so that the light emitting element is caused to display different brightness according to the light emitting duration and the driving current; or, the reference signal data t(n) of each frame is the same, and the magnitudes of the control sub-signal VL1, the control sub-signal VL2, and the control sub-signal VL3 need to be adjusted correspondingly according to the gray-level brightness of the light emitting element in the current frame. FIG. 3 is only an embodiment for illustration, that is, the number, duration, and level of the control sub-signals are not limited. For example, the number of the control sub-signals may be 4, 5, 6 or more. The durations of these control sub-signals become longer in turn, and the level become smaller in turn; and so on.

In some examples, the threshold voltage of the second transistor T9 is Vth, the level of the high-level signal included in the time control signal em1(n) is VH, and the value range of the level VL of the control sub-signal is (VLmin, VLmax). Wherein, the maximum value VLmax can ensure that the first transistor T7 can be kept turned on after it is connected to the gate of the first transistor T7. The high-level signal VH ensures that the first transistor T7 is turned off when it is connected to the gate of the first transistor T7. Then, when (reference signal date t+threshold voltage Vth)<VLmin, all the control sub-signals of the time control signal em1(n) can be written into the gate of the first transistor T7 through the second transistor T9 to ensure that the first transistor T7 turned on, and the light emitting element can emit light. When (reference signal date t+threshold voltage Vth)>VLmax, all the control sub-signals VL of the time control signal em1(n) cannot pass through the second transistor T9, and the first transistor T7 remains off, and the driving current cannot flow from the driving current generation circuit 11 to the light emitting element, and the light emitting element always does not emit light. When VLmin<(reference signal date t+threshold voltage Vth)<VLmax, among the control sub-signals included in the time control signal em1(n), the control sub-signals having a level in the range (reference signal date t+Vth, VLmax) can pass through the second transistors T9, and the first transistor T7 is turned on. In this corresponding period, the driving current generated by the driving current generation circuit 11 passes through the first transistor T7 to the light emitting element, and the light emitting element emits light. On the other hand, among the control sub-signals included in the time control signal em1(n), the control sub-signals having a level in the interval of (VLmin, reference signal date t+threshold voltage Vth) cannot pass through the second transistor T9, and the first transistor T7 is turned off. In this corresponding period, the driving current generated by the driving current generation circuit 11 cannot pass through the first transistor T7, and the light emitting element does not emit light. In this way, the control sub-signal of the time control signal em1(n) to be connected to the gate of the first transistor T7 can be selected according to the level of the reference signal data t(n), so as to control the first transistor T7 to be on or off, thereby controlling the light emitting duration of the light emitting element.

Further referring to FIGS. 1 and 2, in some embodiments, the driving circuit includes a threshold compensation circuit 13, the threshold compensation circuit 13 is connected to the gate of the drive transistor T3, the second electrode of the drive transistor T3, and a gate control terminal GATE(N), and is configured to compensate a threshold voltage of the drive transistor T3 under the control of the gate control terminal GATE(N).

Specifically, the threshold compensation circuit 13 includes a threshold compensation transistor T4, a gate of the threshold compensation transistor T4 is connected to the gate control terminal GATE(N), a first electrode of the threshold compensation transistor T4 is connected to the gate of the drive transistor T3, a second electrode of the threshold compensation transistor T4 is connected to the second electrode of the drive transistor T3.

In some embodiments, the driving circuit 10 includes a data write circuit 14, the data write circuit 14 is connected to the driving current generation circuit 11, the gate control terminal GATE(N) and a data write terminal DATA I, and is configured to write to the data voltage terminal a data voltage data I(n) provided by the data write terminal DATA I under the control of the gate control terminal GATE(N).

The data write circuit 14 includes a data write transistor T2, a gate of the date write transistor T2 is connected to the gate control terminal GATE(N), a first electrode of the data write transistor T2 is connected to the first electrode of the drive transistor T3, a second electrode of the data write transistor T2 is connected to the data write terminal DATA I. The data write transistor T2 writes the data voltage data I(n) of the data write terminal DATA I to the drive transistor T3 according to the gate control signal gate(n) input from the gate control terminal GATE(N), so that the data voltage data I(n) passes through the drive transistor T3 and the threshold compensation transistor T4 and is transmitted to and written to the data voltage terminal Vg.

In some embodiments, the driving circuit 10 includes a light emitting control circuit 15, the light emitting control circuit 15 is connected to the first reference voltage terminal VDD, the light emitting control terminal EMC and the driving current generation circuit 11, and is configured to cause the driving current generation circuit 11 to be connected to the first reference voltage terminal VDD under the control of the light emitting control terminal EMC.

Specifically, the light emitting control circuit 15 includes a light emitting control transistor T5, a gate of the light emitting control transistor T5 is connected to the light emitting control terminal EMC, a first electrode of the light emitting control transistor T5 is connected to the first reference voltage terminal VDD, a second electrode of the light emitting control transistor T5 is connected to the first electrode of the drive transistor T3. Wherein, the light emitting control terminal EMC is configured to transmit the light emitting control signal emc(n) to the light emitting control transistor T5. The light emitting control signal emc(n) is a level signal, including a low-level signal and a high-level signal. When the light emitting control signal emc(n) is a low-level signal, the light emitting control transistor T5 writes the first reference voltage Vdd to the first electrode of the drive transistor T3 according to the light emitting control signal emc(n).

In some embodiments, the driving circuit 10 includes a reset circuit 16, the reset circuit 16 is connected to a reset control terminal GATE(N−1), a reset voltage terminal VIN, the driving current generation circuit 11 and the light emitting time control circuit 12, and is configured to reset the driving current generation circuit 11 and/or the light emitting time control circuit 12 under the control of the reset control terminal GATE(N−1).

It should be noted that, the reset control terminal GATE (N−1) is configured to input the reset control signal gate(n−1) to the reset circuit 16. The reset control signal gate(n−1) is a level signal, including a high-level signal and a low-level signal. The reset voltage terminal VIN is configured to input a reset voltage to the reset circuit 16. The reset voltage terminal VIN is configured to transmit the first reference voltage Vdd and the reset voltage Vinit to the reset circuit 16, where the reset voltage Vinit and the second reference voltage Vss are low-level signals relative to the first reference voltage Vdd.

Specifically, the reset circuit 16 includes a first reset sub-circuit 162 and a second reset sub-circuit 164. Wherein, the first reset sub-circuit 162 is connected to the reset control terminal GATE(N−1), the reset voltage terminal VIN and the driving current generation circuit 11, and is configured to reset the driving current generation circuit 11 under the control of the reset control terminal GATE(N−1). The second reset sub-circuit 164 is connected to the reset control terminal GATE(N−1), the reset voltage terminal VIN and the light emitting time control circuit 12, and is configured to reset the light emitting time control circuit 12 under the control of the reset control terminal GATE(N−1).

Further, the first reset sub-circuit 162 includes a first reset transistor T1, a gate of the first reset transistor T1 is connected to the reset control terminal GATE(N−1), a first electrode of the first reset transistor T1 is connected to the data voltage terminal Vg, a second electrode of the first reset transistor T1 is connected to the reset voltage terminal VIN. When the reset control signal gate(n−1) is a low-level signal, the first reset transistor T1 writes the reset voltage Vinit into the data voltage terminal Vg according to the reset control signal gate(n−1) input from the reset control terminal GATE(N−1), so as to reset the drive transistor T3.

The second reset sub-circuit 164 includes a second reset transistor T6, a gate of the second reset transistor T6 is connected to the reset control terminal GATE(N−1), a first electrode of the second reset transistor T6 is connected to the gate of the first transistor T7, a second electrode of the second reset transistor T6 is connected to the reset voltage terminal VIN. When the reset control signal gate(n−1) is a low-level signal, the second reset transistor T6 is turned on, and the second reset transistor T6 writes the first reference voltage Vdd into the gate of the first transistor T7, so as to reset the first transistor T7.

In some embodiments, the driving circuit 10 includes a voltage regulator circuit 17, the voltage regulator circuit 17 is connected to a common voltage terminal VC, the first reference voltage terminal VDD, the driving current generation circuit 11 and the light emitting time control circuit 12, and is configured to keep control voltages corresponding to the driving current generation circuit 11 and the light emitting time control circuit 12 stable.

Specifically, the voltage regulator circuit 17 includes a first voltage regulator sub-circuit 172, a second voltage regulator sub-circuit 174 and a third voltage regulator sub-circuit 176. Wherein, the first voltage regulator sub-circuit 172 is connected to the first reference voltage terminal VDD and the data voltage terminal Vg. The second voltage regulator sub-circuit 174 is connected to the common voltage terminal VC and the gate of the second transistor T9. The third voltage regulator sub-circuit 176 is connected to the common voltage terminal VC and the gate of the first transistor T7.

It should be noted that, the common voltage terminal VC is used to transmit the common voltage Vcom to the third voltage regulator sub-circuit 176, and the common voltage Vcom is a high-level voltage, that is, if the gate of the transistor receives the common voltage Vcom, the transistor is turned off.

Further, the first voltage regulator sub-circuit 172 includes a first storage capacitor C1, a first electrode of the first storage capacitor C1 is connected to the first reference voltage terminal VDD, a second electrode of the first storage capacitor C1 is connected to the data voltage terminal Vg. The second voltage regulator sub-circuit 174 includes a second storage capacitor C2, a first electrode of the second storage capacitor C2 is connected to the gate of the second transistor T9, a second electrode of the second storage capacitor C2 is connected to the common voltage terminal VC. The third voltage regulator sub-circuit 176 includes a third storage capacitor C3, a first electrode of the third storage capacitor C3 is connected to the gate of the first transistor T7, a second electrode of the third storage capacitor C3 is connected to the common voltage terminal VC.

In some embodiments, the driving circuit 10 includes a reference signal write circuit 18, the reference signal write circuit 18 is connected to the reference signal terminal DATA T, a gate control terminal GATE(N) and the light emitting time control circuit 12, and is configured to cause the light emitting time control circuit 12 to be connected to the reference signal terminal DATA T under the control of the gate control terminal GATE(N).

Specifically, the reference signal write circuit 18 includes a third transistor T8, a gate of the third transistor T8 is connected to the gate control terminal GATE(N), a first electrode of the third transistor T8 is connected to the reference signal terminal DATA T, a second electrode of the third transistor T8 is connected to the gate of the second transistor T9. When the gate control signal gate(n) input at the gate control terminal GATE(N) is a low-level signal, the third transistor T8 is turned on, the reference signal terminal DATA T is connected to the second transistor T9, and the reference signal terminal DATA T writes the reference signal data t(n) into the gate of the third transistor T8.

When the driving circuit 10 of the present application drives the light emitting element to display a frame of image, it includes a reset stage t1, a compensation stage t2, and a light emitting stage t3. The working process of the driving circuit 10 is described below by taking the driving circuit 10 shown in FIG. 2 and the driving timing shown in FIG. 3 as examples.

Wherein, in FIG. 3, in the reset stage t1, the reset control signal gate(n−1) is a low-level signal, and the light emitting control signal emc(n), the gate control signal gate(n), the data voltage data I(n), the reference signal data t(n), and the control signal em1(n) are high-level signals.

The first reset transistor T1 is turned on, the reset voltage Vinit at the reset voltage terminal VIN is written into the data voltage terminal Vg through the first reset transistor T1, the first voltage regulator transistor is charged, and the gate of the drive transistor T3 resets the reset voltage Vinit to drive the transistor T3 on; meanwhile, the second reset transistor T6 is turned on, the first reference voltage Vdd at the first reference voltage terminal VDD is written into the third storage capacitor C3 and the gate of the first transistor T7, and the first transistor T7 is turned off.

In the compensation stage t2, the gate control signal gate(n) is at low level, the reset control signal Gate(n−1), the light emitting control signal emc(n), the data voltage data I(n), the reference signal data t(n) and the control signal em1(n) are at high level. In this case, the data write transistor T2, the drive transistor T3, the threshold compensation transistor T4, and the third transistor T8 are all turned on. In the driving current generation circuit 11, the data signal date I(n) is transmitted to the data voltage terminal Vg by passing through the data write transistor T2, the driving transistor T3 and the threshold compensation transistor T4 sequentially. The first storage capacitor C1 is charged, and when the potential is balanced, the potential of the data voltage terminal Vg is (V_{data I}−Vth); meanwhile, in the light emitting time control circuit 12, the three transistor T8 is turned on under the control of the gate control signal gate(n), the reference signal date t(n) is transmitted to the second storage capacitor C2 and the gate of the second transistor T9 through the third transistor T8. The second transistor T9 controls, through the magnitude of the reference signal date t(n), a corresponding control sub-signal in the time control signal em1(n) to be written into the gate of the first transistor T7, so that the first transistor T7 is turned on.

In the light emitting stage t3, the light emitting control signal emc(n) is at low level, the light emitting control transistor T5 is turned on, the first reference voltage terminal VDD is connected to the drive transistor T3, and the first reference voltage Vdd at the first reference voltage terminal VDD is written into the drive transistor T3. The drive transistor T3 generates a driving current according to the potential of the data voltage terminal Vg and the first reference voltage Vdd, and transmits it to the first transistor T7. The first transistor T7 is turned on according to the control sub-signal of the time control signal em1(n), so that the drive transistor T3 is connected to the light emitting element, and the light emitting element starts to emit light. The light emitting duration is the total durations of the control sub-signals input to the gate of the first transistor T7.

In the driving circuit and the display panel according to the present application, by providing a driving current generation circuit and a light emitting time control circuit, the light emitting time control circuit controls the duration of transmitting the driving current to the light emitting element under the control of both the time control signal and the reference signal terminal. In this way, the gray level is modulated by both the driving current and the light emitting time, which avoids the display color cast of the light emitting element, and improves the display quality.

An embodiment of the present application further provides a driving control method used in the above driving circuit 10, wherein a display period includes a compensation stage and a light emitting stage. The driving control method includes:

S12: in the compensation stage, the data voltage terminal providing and storing a data voltage signal, and the reference signal terminal providing and storing a reference signal;

S14: in the light emitting stage, the time control signal terminal providing multiple segments of time control signals of different magnitudes, the driving current generation circuit generating a driving current under the control of a first reference signal provided by the first reference voltage terminal and the data voltage signal stored by the data voltage terminal, and transmitting the driving current to the light emitting time control circuit 12, the light emitting time control circuit controlling a duration of transmitting the driving current to the light emitting element according to magnitudes of the multiple segments of time control signals and the reference voltage signal and a duration of each segment of time control signal.

It should be noted that, in step S14, the durations of the multiple segments of control sub-signals of different magnitudes are different from each other. The light emitting duration the light emitting element is a sum of the durations of the segments of time control signals which a difference between a signal value and the reference signal is greater than a preset value.

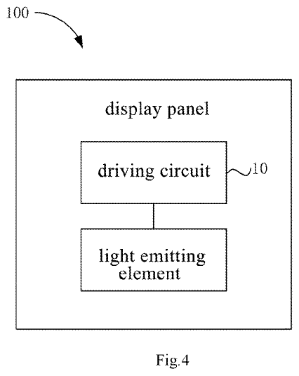

Referring to FIG. 4, the present application further provides a display panel 100. The display panel 100 includes a light emitting element and the driving circuit 10 in any of the above embodiments. The driving circuit 10 is used for driving the light emitting element to emit light.

In some embodiments of the present application, specifically, the display panel 100 includes a plurality of pixels arranged in an array and shift registers sequentially cascaded. Each row of pixels corresponds to a shift register, and each pixel includes a driving circuit 10 and a light emitting element connected thereto. The shift register of the current row can provide the gate control signal, the light emitting control signal and the time control signal for the driving circuit 10 of the current row, and the shift register of the previous row can provide the reset signal for the driving circuit of the current row.

The display panel 100 also includes a plurality of reference signal lines and a plurality of data signal lines, wherein the driving circuits 10 of the same column of pixels are connected to the same data signal line, and/or, the driving circuits 10 of the same column of pixels are connected to the same reference signal line; the driving circuits 10 of the same row of pixels are connected to the same gate control signal line, the same light emitting control signal line, and the same time control signal line. The first reference voltage terminals VDD of all pixels are connected to each other or receive the same signal; the reset voltage terminals VIN of all pixels are connected to each other or receive the same signal; the second reference voltage terminals VSS of all pixels are connected to each other or receive the same signal; the common voltage terminals VC of all pixels are connected to each other or receive the same signal.

In the description of this specification, the description with reference to the terms “one embodiment”, “some embodiments”, “exemplary embodiment”, “example”, “specific example”, or “some examples”, etc. means that the specific features, structures, materials or characteristics described in the embodiments or examples are included in at least one embodiment or example of the present application. In this specification, the schematic descriptions of the above terms does not necessarily refer to the same embodiment or example. Moreover, the described specific features, structures, materials or characteristics can be combined in an appropriate manner in any one or more embodiments or examples.

Although the embodiments of the present application have been shown and described, those of ordinary skill in the art can understand that various changes, modifications, substitutions, and variations can be made to these embodiments without departing from the principle and purpose of the present application. The scope of the application is defined by the claims and their equivalents.

What is claimed is:

1. A driving circuit for driving a light emitting element, wherein the driving circuit comprises a driving current generation circuit and a light emitting time control circuit,
the driving current generation circuit is connected to a first reference voltage terminal, a data voltage terminal and the light emitting time control circuit, and is configured to generate a driving current under the control of the first reference voltage terminal and the data voltage terminal, and transmit the driving current to the light emitting time control circuit;
the light emitting time control circuit is connected to the driving current generation circuit, a time control signal terminal, a reference signal terminal and a light emitting element, and is configured to control a duration of transmitting the driving current to the light emitting element under the control of the time control signal terminal and the reference signal terminal.

2. The driving circuit according to claim 1, wherein the light emitting time control circuit comprises a first transistor and a second transistor,
a first electrode of the first transistor is connected to the driving current generation circuit, a second electrode of the first transistor is connected to the light emitting element;
a gate of the second transistor is connected to the reference signal terminal, a first electrode of the second transistor is connected to the time control signal terminal, a second electrode of the second transistor is connected to a gate of the first transistor.

3. The driving circuit according to claim 2, wherein the driving current generation circuit comprises a drive transistor, the first electrode of the first transistor is connected to a second electrode of the drive transistor, a gate of the drive transistor is connected to the data voltage terminal, a first electrode of the drive transistor is connected to the first reference voltage terminal.

4. The driving circuit according to claim 3, wherein the driving circuit comprises a threshold compensation circuit, the threshold compensation circuit is connected to the gate of the drive transistor, the second electrode of the drive transistor, and a gate control terminal, and is configured to compensate a threshold voltage of the drive transistor under the control of the gate control terminal.

5. The driving circuit according to claim 4, wherein the threshold compensation circuit comprises a threshold compensation transistor, a gate of the threshold compensation transistor is connected to the gate control terminal, a first electrode of the threshold compensation transistor is connected to the gate of the drive transistor, a second electrode of the threshold compensation transistor is connected to the second electrode of the drive transistor.

6. The driving circuit according to claim 5, wherein the driving circuit comprises a data write circuit, the data write circuit is connected to the driving current generation circuit, the gate control terminal and a data write terminal, and is configured to write to the data voltage terminal a data voltage provided by the data write terminal under the control of the gate control terminal.

7. The driving circuit according to claim 6, wherein the data write circuit comprises a data write transistor, a gate of the date write transistor is connected to the gate control terminal, a first electrode of the data write transistor is connected to the first electrode of the drive transistor, a second electrode of the data write transistor is connected to the data write terminal.

8. The driving circuit according to claim 3, wherein the driving circuit comprises a light emitting control circuit, the light emitting control circuit is connected to the first reference voltage terminal, the light emitting control terminal and the driving current generation circuit, and is configured to cause the driving current generation circuit to be connected to the first reference voltage terminal under the control of the light emitting control terminal.

9. The driving circuit according to claim 8, wherein the light emitting control circuit comprises a light emitting control transistor, a gate of the light emitting control transistor is connected to the light emitting control terminal, a first electrode of the light emitting control transistor is connected to the first reference voltage terminal, a second electrode of the light emitting control transistor is connected to the first electrode of the drive transistor.

10. The driving circuit according to claim 2, wherein the driving circuit comprises a reset circuit, the reset circuit is connected to a reset control terminal, a reset voltage terminal, the driving current generation circuit and the light emitting time control circuit, and is configured to reset the driving current generation circuit and/or the light emitting time control circuit under the control of the reset control terminal.

11. The driving circuit according to claim 10, wherein the reset circuit comprises a first reset sub-circuit and a second reset sub-circuit;
the first reset sub-circuit is connected to the reset control terminal, the reset voltage terminal and the driving current generation circuit, and is configured to reset the driving current generation circuit under the control of the reset control terminal;
the second reset sub-circuit is connected to the reset control terminal, the reset voltage terminal and the light emitting time control circuit, and is configured to reset the light emitting time control circuit under the control of the reset control terminal.

12. The driving circuit according to claim 11, wherein the first reset sub-circuit comprises a first reset transistor, a gate of the first reset transistor is connected to the reset control terminal, a first electrode of the first reset transistor is connected to the data voltage terminal, a second electrode of the first reset transistor is connected to the reset voltage terminal;
the second reset sub-circuit comprises a second reset transistor, a gate of the second reset transistor is connected to the reset control terminal, a first electrode of the second reset transistor is connected to the gate of the first transistor, a second electrode of the second reset transistor is connected to the reset voltage terminal.

13. The driving circuit according to claim 2, wherein the driving circuit comprises a voltage regulator circuit, the voltage regulator circuit is connected to a common voltage terminal, the first reference voltage terminal, the driving current generation circuit and the light emitting time control circuit, and is configured to keep control voltages corresponding to the driving current generation circuit and the light emitting time control circuit stable.

14. The driving circuit according to claim 13, wherein the voltage regulator circuit comprise a first voltage regulator sub-circuit, a second voltage regulator sub-circuit and a third voltage regulator sub-circuit;
the first voltage regulator sub-circuit is connected to the first reference voltage terminal and the data voltage terminal;
the second voltage regulator sub-circuit is connected to the common voltage terminal and the gate of the second transistor;
the third voltage regulator sub-circuit is connected to the common voltage terminal and the gate of the first transistor.

15. The driving circuit according to claim 14, wherein the first voltage regulator sub-circuit comprises a first storage capacitor, a first electrode of the first storage capacitor is connected to the first reference voltage terminal, a second electrode of the first storage capacitor is connected to the data voltage terminal;
the second voltage regulator sub-circuit comprises a second storage capacitor, a first electrode of the second storage capacitor is connected to the gate of the second transistor, a second electrode of the second storage capacitor is connected to the common voltage terminal;
the third voltage regulator sub-circuit comprises a third storage capacitor, a first electrode of the third storage capacitor is connected to the gate of the first transistor, a second electrode of the third storage capacitor is connected to the common voltage terminal.

16. The driving circuit according to claim 2, wherein the driving circuit comprises a reference signal write circuit, the reference signal write circuit is connected to the reference signal terminal, a gate control terminal and the light emitting time control circuit, and is configured to cause the light emitting time control circuit to be connected to the reference signal terminal under the control of the gate control terminal.

17. The driving circuit according to claim 16, wherein the reference signal write circuit comprises a third transistor, a gate of the third transistor is connected to the gate control terminal, a first electrode of the third transistor is connected to the reference signal terminal, a second electrode of the third transistor is connected to the gate of the second transistor.

18. A driving control method for the driving circuit according to claim 1, wherein a display period comprises a compensation stage and a light emitting stage, and the driving control method comprises:
in the compensation stage, the data voltage terminal providing and storing a data voltage signal, and the reference signal terminal providing and storing a reference signal;
in the light emitting stage, the time control signal terminal providing multiple segments of time control signals with different magnitudes, the driving current generation circuit generating a driving current under the control of a first reference signal provided by the first reference voltage terminal and the data voltage signal stored by the data voltage terminal, and transmitting the driving current to the light emitting time control circuit, the light emitting time control circuit controlling a duration of transmitting the driving current to the light emitting element according to magnitudes of the multiple segments of time control signals and the reference voltage signal and a duration of each segment of time control signal.

19. The driving control method according to claim 18, wherein a light emitting duration of the light emitting element is a sum of the durations of the segments of time control signals which a difference between a signal value and the reference signal is greater than a preset value.

20. A display panel, comprising a light emitting element and the driving circuit according to claim 1, the driving circuit being used for driving the light emitting element to emit light.
